(19) United States
(12) Patent Application Publication
(10) Pub. No.: US 2022/0322508 A1
(43) Pub. Date: Oct. 6, 2022

(54) BACKLIGHT MODULE AND DISPLAY DEVICE

(71) Applicant: TCL CHINA STAR OPTOELECTRONICS TECHNOLOGY CO., LTD., Shenzhen (CN)

(72) Inventor: Lixuan Chen, Shenzhen (CN)

(73) Assignee: TCL CHINA STAR OPTOELECTRONICS TECHNOLOGY CO., LTD., Shenzhen (CN)

(21) Appl. No.: 17/057,661

(22) PCT Filed: Nov. 12, 2020
(86) PCT No.: PCT/CN2020/128351

§ 371 Date: Nov. 21, 2020

(30) Foreign Application Priority Data
Oct. 29, 2020 (CN) 202011179255.0

(51) Int. Cl. H05B 45/30

(52) U.S. Cl. CPC H05B 45/30

(57) ABSTRACT

A backlight module and a display device are disclosed. By allowing one backlight in a set of light sources controlled by one of driving devices to be spaced at least one row and/or one column apart from at least another backlight in the set of light sources controlled by the one of the driving devices, the present disclosure can effectively reduce influences of local dark areas caused by defects occurred in the set of light sources controlled by the one of the driving devices, and ensures normal display of the display device.

### FIELD OF INVENTION

The present disclosure relates to the field of display panel technologies, and more particularly, to a backlight module and a display device.

### BACKGROUND OF INVENTION

Light-emitting diodes (LEDs) as light sources in fine local control of liquid crystal displays (LCDs) are getting more and more attention. For example, using an amorphous silicon thin film transistor (αSi-TFT) glass substrate as a backlight control substrate can support very highly partitioned LED backlights.

Current LEDs use low power chips, so a number of chips that can be integrated is limited, and because the low power chips have a small size, when welding wires, wire arcs are too long, making it difficult to manufacture, and there is a risk of breaking wires. Therefore, at present, the LEDs have natural defects, and a defective rate thereof is about one out of a million. If one of the LEDs has an open circuit, it will cause other LEDs connected to this LED to not emit light, either, thereby causing backlights to have obvious dark areas and affecting display effect.

Technical problem: an embodiment of the present disclosure provides a backlight module and a display device, which effectively solves problems of obvious dark areas existing in backlights of the backlight module caused by a same set of LEDs unable to be lit up due to one defective LED in the same set of LEDs.

### SUMMARY OF INVENTION

According to one aspect of the present disclosure, an embodiment of the present disclosure provides a backlight module, which includes: a plurality of backlights arranged in a plurality of rows and columns; and a plurality of driving devices, wherein each of the driving devices controls at least two of the backlights; wherein one of the at least two of the backlights is spaced at least one row and/or one column apart from at least another one of the at least two of the backlights.

Further, the at least two of the backlights are connected in series.

Further, each of the driving devices controls a first backlight, a second backlight, a third backlight, and a fourth backlight.

Further, the first backlight and the second backlight are positioned in a same row and spaced one column apart from each other.

Further, the first backlight and the third backlight are positioned in a same column and spaced one row apart from each other.

Further, the first backlight and the fourth backlight are spaced one column and one row apart from each other.

Further, the backlights controlled by one of the driving devices and the backlights controlled by another one of the driving devices are arranged alternatingly.

Further, each of the driving devices includes: a switch transistor, wherein a source electrode of the switch transistor is connected to a first node; a driving transistor, wherein a gate electrode of the driving transistor is connected to the first node; and a storage capacitor with one end connected to a negative voltage and another end connected to the first node.

Further, the backlights controlled by each of the driving devices are arranged spaced apart from each other.

According to another aspect of the present disclosure, an embodiment of the present disclosure provides a display device including any one of the above backlight modules.

Beneficial effect: advantages of the present disclosure is that compared to current technology, by allowing one backlight in a set of light sources controlled by one of driving devices to be spaced at least one row and/or one column apart from at least another backlight in the set of light sources controlled by the one of the driving devices, the present disclosure can effectively reduce influences of local dark areas caused by defects occurred in the set of light sources controlled by the one of the driving devices, and ensures normal display of the display device.

### DESCRIPTION OF DRAWINGS

The accompanying figures to be used in the description of embodiments of the present disclosure will be described in brief to more clearly illustrate the technical solutions of the embodiments. The accompanying figures described below are only a part of the embodiments of the present disclosure, from which those skilled in the art can derive further figures without making any inventive efforts.

FIG. 1 is a schematic circuit structural diagram of a backlight module according to an embodiment of the present disclosure.

FIG. 2 is a schematic arrangement diagram of backlights according to embodiment 1 of the present disclosure.

FIG. 3 is a schematic arrangement diagram of backlights according to embodiment 2 of the present disclosure.

FIG. 4 is a schematic arrangement diagram of backlights according to embodiment 3 of the present disclosure.

FIG. 5 is a schematic arrangement diagram of backlights according to embodiment 4 of the present disclosure.

FIG. 6 is a schematic structural diagram of a display device according to an embodiment of the present disclosure.

### DETAILED DESCRIPTION OF PREFERRED EMBODIMENTS

The technical solutions in the embodiments of the present disclosure will be clearly and completely described below with reference to the drawings in the embodiments of the present disclosure. Obviously, the described embodiments are only a part of the embodiments of the present disclosure, but not all the embodiments. Based on the embodiments in the present disclosure, all other embodiments obtained by those skilled in the art without creative efforts are within the scope of the present disclosure.

In the description of the present disclosure, it should be understood that terms such as “center”, “longitudinal”, “lateral”, “length”, “width”, “thickness”, “upper”, “lower”, “front”, “rear”, “left”, “right”, “vertical”, “horizontal”, “top”, “bottom”, “inside”, “outside”, “clockwise”, “counter-clockwise”, as well as derivative thereof should be construed to refer to the orientation as described or as shown in the drawings under discussion. These relative terms are for convenience of description, do not require that the present disclosure be constructed or operated in a particular orientation, and shall not be construed as causing limitations to the present disclosure. In addition, terms such as “first” and “second” are used herein for purposes of description and are not intended to indicate or imply relative importance or implicitly indicating the number of technical features indicated. Thus, features limited by “first” and “second” are intended to indicate or imply including one or more than one these features. In the description of the present disclosure, “a plurality of” relates to two or more than two, unless otherwise specified.

In the description of the present disclosure, it should be noted that unless there are express rules and limitations, the terms such as “mount,” “connect,” and “bond” should be comprehended in broad sense. For example, it can mean a permanent connection, a detachable connection, or an integrated connection; it can mean a mechanical connection, an electrical connection, or can communicate with each other; it can mean a direct connection, an indirect connection by an intermediator, or an inner communication or an inter-reaction between two elements. A person skilled in the art should understand the specific meanings in the present disclosure according to specific situations. In this embodiment, a analog display screen touch unit is connected to a head tracking unit, and is used to obtain a movement path of a sensing cursor in a display device.

In the description of the present disclosure, unless specified or limited otherwise, it should be noted that, a structure in which a first feature is “on” or “beneath” a second feature may include an embodiment in which the first feature directly contacts the second feature and may also include an embodiment in which an additional feature is formed between the first feature and the second feature so that the first feature does not directly contact the second feature. Furthermore, a first feature “on,” “above,” or “on top of” a second feature may include an embodiment in which the first feature is right “on,” “above,” or “on top of” the second feature and may also include an embodiment in which the first feature is not right “on,” “above,” or “on top of” the second feature, or just means that the first feature has a sea level elevation greater than the sea level elevation of the second feature. While first feature “beneath,” “below,” or “on bottom of” a second feature may include an embodiment in which the first feature is right “beneath,” “below,” or “on bottom of” the second feature and may also include an embodiment in which the first feature is not right “beneath,” “below,” or “on bottom of” the second feature, or just means that the first feature has a sea level elevation less than the sea level elevation of the second feature.

The following description provides many different embodiments or examples for implementing different structures of the present disclosure. In order to simplify the present disclosure, the components and settings of a specific example are described below. Of course, they are merely examples and are not intended to limit the present disclosure. In addition, the present disclosure may repeat reference numerals and/or reference letters in different examples, which are for the purpose of simplicity and clarity, and do not indicate the relationship between the various embodiments and/or arrangements discussed. In addition, the present disclosure provides examples of various specific processes and materials, but one of ordinary skill in the art will recognize the use of other processes and/or the use of other materials.

An embodiment of the present disclosure provides a display module. The display module includes: a plurality of backlights 10 arranged in a plurality of rows and columns; and a plurality of driving devices 30, wherein each of the driving devices 30 controls at least two of the backlights 10; wherein one of the at least two of the backlights 10 is spaced at least one row and/or one column apart from at least another one of the at least two of the backlights 10.

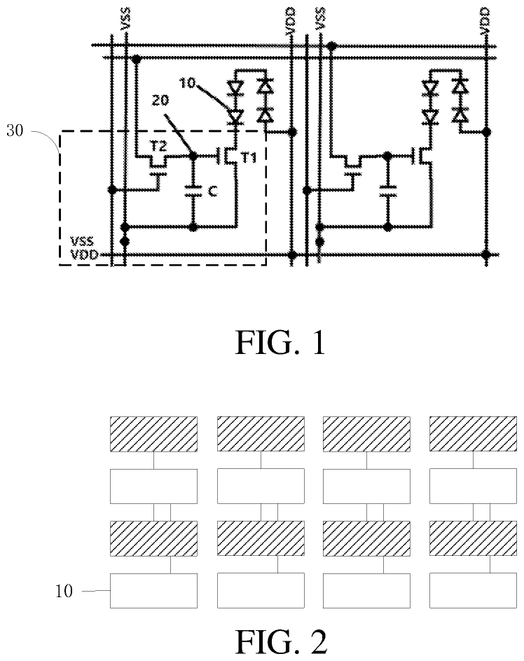

As shown in FIG. 1, FIG. 1 is a schematic circuit structural diagram of a backlight module according to an embodiment of the present disclosure. The at least two of the backlights 10 are connected in series. It should be noted that in FIG. 1 of the present disclosure, each of the driving devices 30 controls four backlights 10, but it is not limited to this. For example, it may also be that each of the driving devices 30 controls six backlights 10 or that each of the driving devices 30 controls eight backlights 10. In other embodiments, other numbers of backlights 10 can be set according to needs. Affected by a charging capacity of a capacitor in each of the driving devices 30, a number of the backlights 10 controlled by each of the driving devices 30 cannot exceed ten.

Each of the driving devices 30 controls a first backlight, a second backlight, a third backlight, and a fourth backlight. In some embodiments, the first backlight and the second backlight are positioned in a same row and spaced one column apart from each other. In some embodiments, the first backlight and the third backlight are positioned in a same column and spaced one row apart from each other. In some embodiments, the first backlight and the fourth backlight are spaced one column and one row apart from each other.

Each of the driving devices 30 includes: a switch transistor T2, wherein a source electrode of the switch transistor T2 is connected to a first node 20; a driving transistor T1, wherein a gate electrode of the driving transistor T1 is connected to the first node 20; and a storage capacitor C with one end connected to a negative voltage VSS and another end connected to the first node 20. An anode of the backlights 10 is connected to a positive voltage VDD.

As shown in FIG. 2, FIG. 2 is a schematic arrangement diagram of the backlights 10 according to embodiment 1 of the present disclosure.

Wherein, each of the driving devices 30 controls two backlights 10. For convenience of description, a position of the backlights 10 in a lower left corner of FIG. 2 is represented by coordinates (1, 1).

It can be seen that in embodiment 1, coordinates of the backlights 10 controlled by one of the driving devices 30 are (1,1) and (1,3). Coordinates of the backlights 10 controlled by another one of the driving devices 30 and separated from the backlights 10 controlled by the one of the driving devices 30 are (1,2) and (1,4). As such, in the backlights 10 controlled by the one of the driving devices 30, when the backlight 10 with coordinates (1,1) has defects (such as open circuits), due to series connection, the backlight 10 with coordinates (1,3) will not be lit up, either. At this time, since the backlights 10 in adjacent positions, such as the backlights 10 with coordinates (1,2) and (1,4) or the backlights 10 with coordinates (2,1) and (2,3), are controlled by different driving devices 30, the adjacent positions can still emit light normally, thereby effectively reducing influences of local dark areas caused by defects occurred in one set of light sources controlled by one of the driving devices 30, and ensures normal display of a display device.

Advantages of the present disclosure is that compared to current technology, by allowing one backlight in a set of light sources controlled by one of the driving devices to be spaced at least one row and/or one column apart from at least another backlight in the set of light sources controlled by the one of the driving devices, the present disclosure can effectively reduce influences of local dark areas caused by defects occurred in the set of light sources controlled by the one of the driving devices, and ensures normal display of the display device.

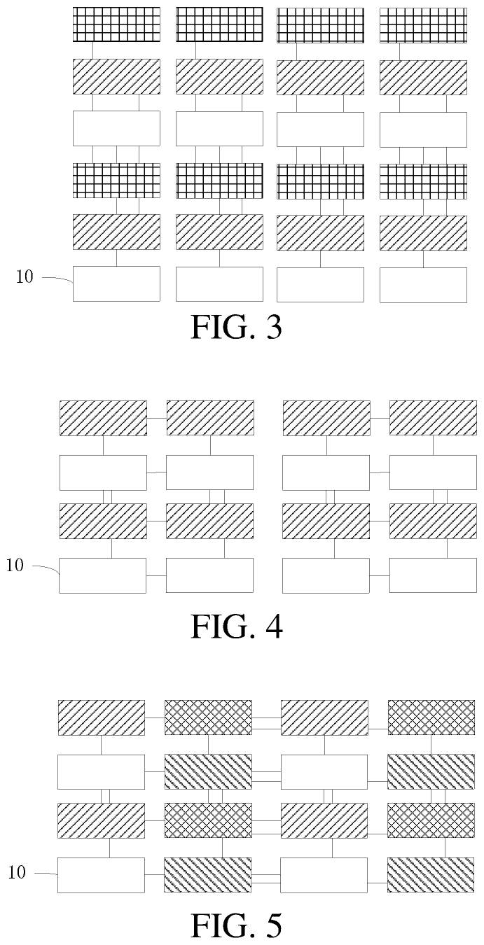

As shown in FIG. 3, FIG. 3 is a schematic arrangement diagram of the backlights 10 according to embodiment 2 of the present disclosure.

Wherein, each of the driving devices 30 controls two backlights 10. For convenience of description, a position of the backlights 10 in a lower left corner of FIG. 3 is represented by coordinates (1, 1).

It can be seen that in embodiment 2, coordinates of the backlights 10 controlled by one of the driving devices 30 are (1,1) and (1,4). Coordinates of adjacent backlights 10 controlled by another two of the driving devices 30 are (1,2), (1,5), (1,3), and (1,6). As such, in the backlights 10 controlled by the one of the driving devices 30, when the backlight 10 with coordinates (1,1) has defects (such as open circuits), due to series connection, the backlight 10 with coordinates (1,4) will not be lit up, either. At this time, since the backlights 10 in adjacent positions, such as the backlights 10 with coordinates (1,2) and (1,3) or the backlights 10 with coordinates (2,1) and (2,4), are controlled by different driving devices 30, the adjacent positions can still emit light normally, thereby effectively reducing influences of local dark areas caused by defects occurred in one set of light sources controlled by one of the driving devices 30, and ensures normal display of the display device.

Advantages of the present disclosure is that compared to current technology, by allowing one backlight in a set of light sources controlled by one of the driving devices to be spaced at least one row and/or one column apart from at least another backlight in the set of light sources controlled by the one of the driving devices, the present disclosure can effectively reduce influences of local dark areas caused by defects occurred in the set of light sources controlled by the one of the driving devices, and ensures normal display of the display device.

As shown in FIG. 4, FIG. 4 is a schematic arrangement diagram of the backlights 10 according to embodiment 3 of the present disclosure.

Wherein, each of the driving devices 30 controls four backlights 10. For convenience of description, a position of the backlights 10 in a lower left corner of FIG. 4 is represented by coordinates (1, 1).

It can be seen that in embodiment 3, coordinates of the backlights 10 controlled by one of the driving devices 30 are (1,1), (1,3), (2,1), and (2,3). Coordinates of adjacent backlights 10 controlled by another one of the driving devices 30 are (1,2), (1,4), (2,2), and (2,4). As such, in the backlights 10 controlled by the one of the driving devices 30, when the backlight 10 with coordinates (1,1) has defects (such as open circuits), due to series connection, the backlights 10 with coordinates (1,3), (2,1), and (2,3) will not be lit up, either. At this time, since the backlights 10 in adjacent positions, such as the backlights 10 with coordinates (1,2), (1,4), (2,2), and (2,4), are controlled by different driving devices 30, the adjacent positions can still emit light normally, thereby effectively reducing influences of local dark areas caused by defects occurred in one set of light sources controlled by one of the driving devices 30, and ensures normal display of the display device.

Advantages of the present disclosure is that compared to current technology, by allowing one backlight in a set of light sources controlled by one of the driving devices to be spaced at least one row and/or one column apart from at least another backlight in the set of light sources controlled by the one of the driving devices, the present disclosure can effectively reduce influences of local dark areas caused by defects occurred in the set of light sources controlled by the one of the driving devices, and ensures normal display of the display device.

As shown in FIG. 5, FIG. 5 is a schematic arrangement diagram of the backlights 10 according to embodiment 4 of the present disclosure.

Wherein, each of the driving devices 30 controls four backlights 10. For convenience of description, a position of the backlights 10 in a lower left corner of FIG. 5 is represented by coordinates (1, 1).

It can be seen that in embodiment 4, coordinates of the backlights 10 controlled by one of the driving devices 30 are (1,1) (a first backlight), (1,3) (a second backlight), (3,1) (a third backlight), and (3,3) (a fourth backlight). In addition, from the coordinates of the backlights 10, it can be seen that the backlights controlled by the one of the driving devices are spaced apart from each other, and coordinates of adjacent backlights 10 controlled by another driving devices 30 are (1,2), (1,4), (2,1), and (2,3). It can also be seen that the backlights controlled by the one of the driving devices and the backlights controlled by another one of the driving devices are arranged alternatingly. As such, in the backlights 10 controlled by the one of the driving devices 30, when the backlight 10 with coordinates (1,1) has defects (such as open circuits), due to series connection, the backlights 10 with coordinates (1,3), (3,1), and (3,3) will not be lit up, either. At this time, since the backlights 10 in adjacent positions, such as the backlights 10 with coordinates (1,2), (1,4), (2,1), and (2,3), are controlled by different driving devices 30, the adjacent positions can still emit light normally, thereby effectively reducing influences of local dark areas caused by defects occurred in one set of light sources controlled by one of the driving devices 30, and ensures normal display of the display device.

Advantages of the present disclosure is that compared to current technology, by allowing one backlight in a set of light sources controlled by one of the driving devices to be spaced at least one row and/or one column apart from at least another backlight in the set of light sources controlled by the one of the driving devices, the present disclosure can effectively reduce influences of local dark areas caused by defects occurred in the set of light sources controlled by the one of the driving devices, and ensures normal display of the display device.

From the above embodiments, it can be seen that when there are more rows or columns between the backlights 10 controlled by one of the driving devices 30, the influences of local dark areas caused by defects occurred in the backlights 10 controlled by the one of the driving devices 30 will be less.

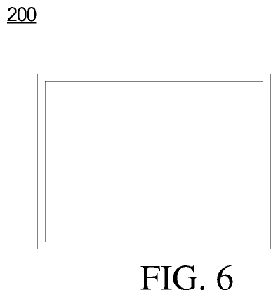

As shown in FIG. 6, FIG. 6 is a schematic structural diagram of a display device according to an embodiment of the present disclosure. The display device 200 includes any one of the backlight modules described above.

The display device 200 may be any product or component having a display function, such as a mobile phone, a tablet computer, a television, a monitor, a notebook computer, a digital photo frame, a navigator, etc.

When the display device 200 of this embodiment uses the backlight module described in the above embodiments, the display effect thereof can be better.

Of course, the display device 200 of the embodiment may also include other conventional structures, such as power supply units, display driving units, etc.

In the above embodiments, the description of each embodiment has its own emphasis. For the parts that are not described in detail in an embodiment, refer to the detailed description of other embodiments above.

The specific examples are applied in the description to explain the principle and implementation of the disclosure. The description of the above embodiments is only for helping to understand the technical solution of the present disclosure and its core ideas, and it is understood that many changes and modifications to the described embodiment can be carried out without departing from the scope and the spirit of the disclosure that is intended to be limited only by the appended claims.

What is claimed is:

1. A backlight module, comprising:
a plurality of backlights arranged in a plurality of rows and columns; and
a plurality of driving devices, wherein each of the driving devices controls at least two of the backlights;
wherein one of the at least two of the backlights is spaced at least one row and/or one column apart from at least another one of the at least two of the backlights.

2. The backlight module according to claim 1, wherein the at least two of the backlights are connected in series.

3. The backlight module according to claim 1, wherein each of the driving devices controls a first backlight, a second backlight, a third backlight, and a fourth backlight.

4. The backlight module according to claim 3, wherein the first backlight and the second backlight are positioned in a same row and spaced one column apart from each other.

5. The backlight module according to claim 3, wherein the first backlight and the third backlight are positioned in a same column and spaced one row apart from each other.

6. The backlight module according to claim 3, wherein the first backlight and the fourth backlight are spaced one column and one row apart from each other.

7. The backlight module according to claim 1, wherein the backlights controlled by one of the driving devices and the backlights controlled by another one of the driving devices are arranged alternatingly.

8. The backlight module according to claim 1, wherein each of the driving devices comprises:
a switch transistor, wherein a source electrode of the switch transistor is connected to a first node;
a driving transistor, wherein a gate electrode of the driving transistor is connected to the first node; and
a storage capacitor with one end connected to a negative voltage and another end connected to the first node.

9. The backlight module according to claim 1, wherein the backlights controlled by each of the driving devices are arranged spaced apart from each other.

10. A display device, comprising the backlight module according to claim
